(19) United States
(12) Patent Application Publication
(10) Pub. No.: US 2009/0275242 A1
(43) Pub. Date: Nov. 5, 2009

(54) COMBINED POWER AND DATA TRANSMISSION CABLE CONNECTOR SYSTEMS

(75) Inventors: Demir Erten, Huntington Beach, CA (US); Brian A. Brown, Camarillo, CA (US); Allan Kidd, Hermosa Beach, CA (US)

Correspondence Address: Parul P. Kamdar;KING & SPALDING LLP, Suite 4000, 1100 Louisiana Street, Houston, TX, 77002, US

(73) Assignee: Cooper Technologies Company, Houston, TX (US)

(21) Appl. No.: 12/434,198

(22) Filed: May 1, 2009

Related U.S. Application Data
(60) Provisional application No. 61/049,973, filed on May 2, 2008.

(51) Int. Cl. H01R 24/00

(52) U.S. Cl. 439/660

(57) ABSTRACT

A connector system includes a plug and receptacle. The plug mates with the receptacle to connect two lengths of an Ethernet/power cable. Connector plugs and receptacles each include an insert assembly having a plurality of contacts for coupling to power conductors and network wires within the Ethernet/power cable. Contacts coupled to power conductors are shielded from contacts coupled to network wires.

### CROSS-REFERENCE TO RELATED APPLICATIONS

The present application claims priority to U.S. Provisional Patent Application No. 61/049,973, titled “Combined Power and Data Transmission Cable Connector Systems” and filed on May 2, 2008, in the name of Demir Erten et al, the entire disclosure of which is hereby fully incorporated herein by reference.

### TECHNICAL FIELD

The application relates generally to power and data transmission cable connector systems for use in harsh environments.

### BACKGROUND OF THE INVENTION

Connectors are typically used to join lengths of cables that supply power or transmit data (e.g., Ethernet). Such connectors may be used, for example, in military applications, shipboard, deep sea applications, oilfield systems, and other harsh environments. The connectors include a number of contacts for coupling to power conductors within a power cable or to network wires within a data transmission cable. A different connector is used for data transmission than a connect used for supplying power. The use of multiple connectors for multiple cables in a single area results in wasted space and increased costs. Furthermore, combining the power conductors and data transmission cables in a single cable for use with a single connector has not been a feasible option in the past. These attempts generally produce “noise” when the power contacts interfere with the network contacts and also generates “cross-talk” between the network wires. The presence of noise and cross-talk results in signal loss or data transmission with errors.

Therefore, a need exists for an improved connector system that includes a combined power and data transmission cable without compromising the quality of data transfer caused by noise and cross-talk.

### SUMMARY OF THE INVENTION

The present invention satisfies the above-described need by providing a connector capable of joining two lengths of a cable having both power conductors and network wires therein. Generally, the connectors of the present invention include a plug and a receptacle. The plug and receptacle are configured to each receive the cable having both power conductors and network wires, while preventing noise and/or cross-talk within.

In one embodiment, a connector includes a plug and a receptacle. The receptacle includes an insert assembly disposed within a housing and having a plurality of contacts or pins recessed therein. The plug includes an insert assembly disposed within a housing and having a plurality of contacts or pins protruding therefrom. The connectors are configured such that the plug contacts insert into the receptacle insert assembly and contact the receptacle contacts. In certain aspects, the plug and receptacle housings are configured for mating engagement.

In another embodiment, a connector is coupled to two lengths of Ethernet/power cable. The Ethernet/power cable includes power conductors and network wires. The power conductors are coupled to a first number of contacts on the plug and/or receptacle and the network wires are coupled to a second number of contacts on the plug and/or receptacle. The power conductors are shielded from the network wires by grounding pins. In certain aspects, the network wires are separated in network pairs. One network pair can be shielded from another network pair using grounding pins. In certain aspects, the first number of contacts have a different diameter than the second number of contacts. In certain aspects, the first number of contacts have a diameter of about 3/32 of an inch and the second number of contacts have a diameter of about 1/16 of an inch.

These and other aspects, objects, features, and embodiments of the present invention will become apparent to those having ordinary skill in the art upon consideration of the following detailed description of illustrative embodiments exemplifying the best mode for carrying out the invention as presently perceived.

### BRIEF DESCRIPTION OF THE DRAWINGS

FIG. 1 is a perspective view showing a cross-section of an Ethernet/power cable, according to an exemplary embodiment.

FIG. 2 is a side view of an connector system having a connector and an Ethernet/power cable, according to an exemplary embodiment.

FIG. 3 is a front view of a receptacle of the connector of FIG. 1, illustrating a contact pin configuration for use with an Ethernet/power cable, according to an exemplary embodiment.

FIG. 4 is a front view of a receptacle, illustrating a contact pin configuration for use with an Ethernet/power cable, according to another exemplary embodiment.

FIG. 5 is a front view of a receptacle, illustrating a contact pin configuration for use with an Ethernet/power cable, according to yet another exemplary embodiment.

FIG. 6 is a front view of a receptacle, illustrating a contact pin configuration for use with an Ethernet/power cable, according to yet another exemplary embodiment.

FIG. 7 is a front view of a receptacle, illustrating a contact pin configuration for use with an Ethernet/power cable, according to yet another exemplary embodiment.

### DETAILED DESCRIPTION OF THE INVENTION

The invention provides a connector for joining two lengths of a single cable containing data transmission wires and power conductors, which is referred to herein as a “Ethernet/power cable.” However, the cable and the connector are not intended to be limited to Ethernet or a network and can include any type of data transmission cables or wires. The connector includes a plug and a receptacle. The plug and receptacle are configured to receive a length of Ethernet/power cable. The connector systems described herein can have high performance capabilities for both general purposes and harsh environments.

The plugs and receptacles can be configured in a variety of sizes and can include a varying amount of contacts for receiving power or data transmission. The contacts can include power conductor pins, network pair pins, and grounding pins. The power conductor pins are coupled to power conductors within an Ethernet/power cable, the network pair pins are coupled to pairs of data transmission wires within an Ethernet/power cable, and the grounding pins are grounded. The grounding pins can be positioned between the power conductor pins and the network pair pins so as to shield the power conductor pins from the network pair pins and minimize or eliminate noise. The grounding pins can also be positioned between pairs of network pair pins to minimize or eliminate cross-talk. The contacts can be configured any number of ways so long as the power conductor pins are shielded from the network pair pins. In certain embodiments, the power conductor pins may be positioned below the grounding pins and network pair pins. In certain alternative embodiments, the power conductor pins may be positioned above the grounding pins and network pair pins. The contacts can be assigned in a variety of ways depending on the application and Ethernet/power cable.

The present invention may be better understood by reading the following description of non-limitative embodiments with reference to the attached drawings wherein like parts of each of the several figures are identified by the same reference characters, and which are briefly described as follows.

### Ethernet/Power Cable

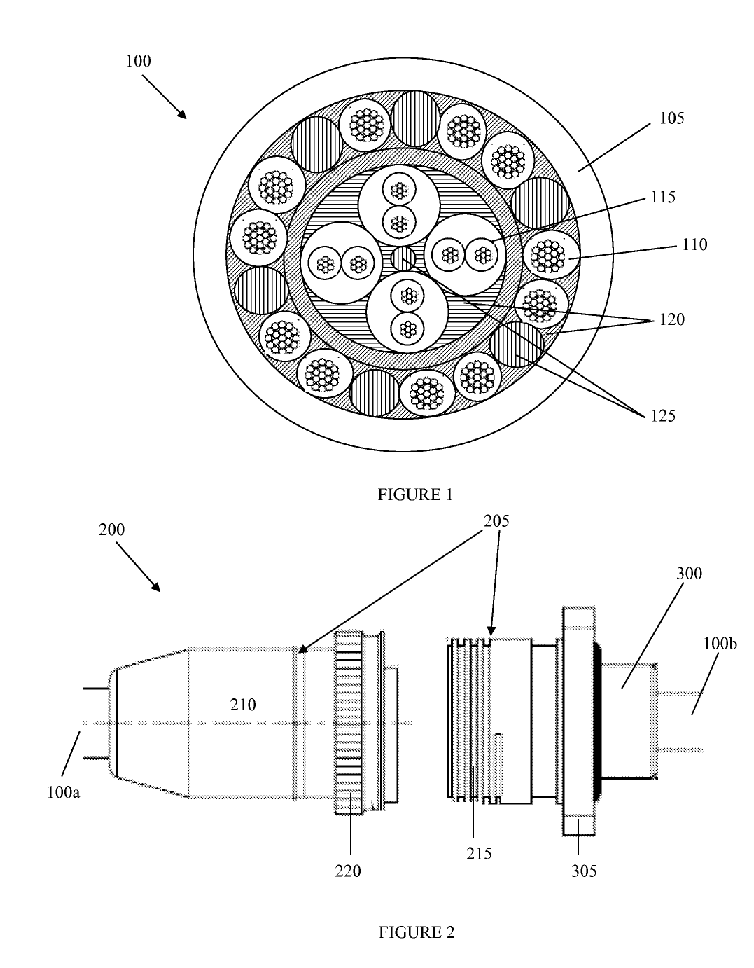

FIG. 1 is a perspective view showing a cross-section of an Ethernet/power cable 100 according to an exemplary embodiment. The Ethernet/power cable 100 includes a single jacket 105 enclosing a plurality of power conductors 110 and network pairs 115, filler material 120, and Kevlar braid strength members 125. In certain embodiments, the network pairs 115 are formed by separating network wires into pairs and shielding them with an Aluminum Mylar tape over #36 AWG Tin Copper Braid wiring to prevent electromagnetic interference between unshielded pairs. In certain embodiments, the network pairs 115 are twisted. In certain exemplary embodiments, the Ethernet/power cable 100 includes Category 5 Enhanced 1000BASE-T network wiring.

The amount of power conductors 110 and network pairs 115 can vary depending upon the application and power needs. In certain embodiments, the Ethernet/power cable 100 includes three power conductors 110 and four twisted network pairs 115. In an alternative embodiment, the Ethernet/power cable 100 includes five power conductors 110 and four twisted network pairs 115. In another embodiment, the Ethernet/power cable 100 includes eight power conductors 110 and four twisted network pairs 115. In yet another embodiment, the Ethernet/power cable 100 includes fifteen power conductors 110 and four twisted network pairs 115. Furthermore, the size/diameter of a given Ethernet/power cable 100 can be substantially similar to the size/diameter of a conventional power cable (not shown) having an equal number of power conductors. For example, an Ethernet/power cable 100 having X network pairs 115 and Y power conductors 110 can be substantially similar in size to a power cable having only Y power conductors.

The jacket 105 of the Ethernet/power cable 100 can be a 0.125 inch thick neoprene black jacket. The jacket 105 encloses the wiring (power conductors 110 and network pairs 115) and filler material 120 to maintain a waterproof casing and allows a rubber over-molding bond between the cable 100 and a connector (not shown).

The optional filler material 120 can be made of a void-filling compound, such as a liquid that hardens and eliminates air that may be present in the cable 100. A number of void-filling compounds 120 currently exist, and one having ordinary skill in the art will recognize suitable void-filling compounds 120 that may be used. The presence of the void-filling compound 120 in the Ethernet/power cable 100 allows the cable 100 to be used in severe applications, such as deep sea environments. The void filling compound 120 may provide compression resistance from equal hydrostatic pressure exterior to the cable 100, thus preventing the twisted network pairs 115 from compressing into each other. As a result, the presence of the void-filling compound 120 may reduce cross-talk.

The Kevlar braid strength members 125 are strength members that provide tension strength to the cable 100, and may aid in eliminating possible splitting of the power conductors 110.

### Connector Configurations

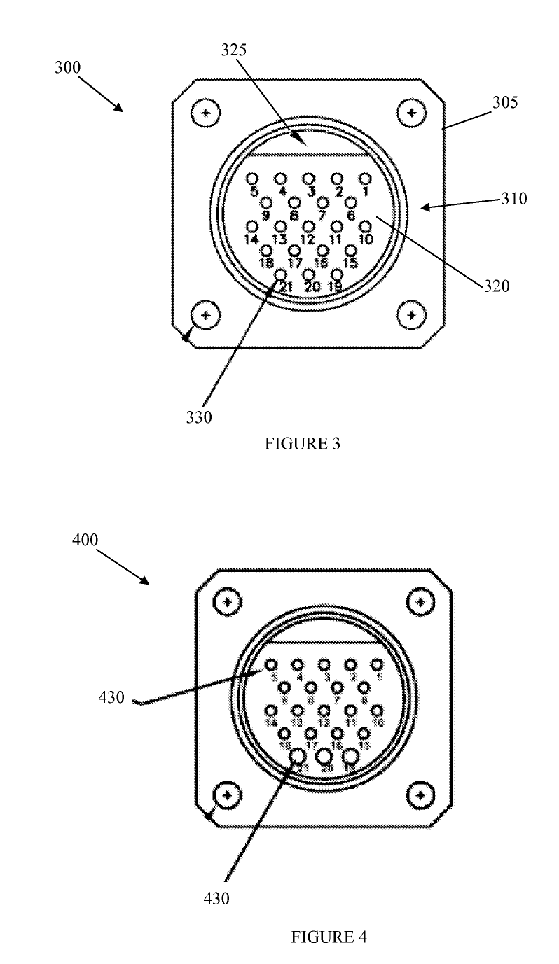

FIG. 2 is a side view of a connector system 200 having a connector 205 and Ethernet/power cables 100a, 100b, according to an exemplary embodiment. The connector 205 can connect the two lengths of Ethernet/power cable 100a, 100b together. The connector 205 includes a plug 210 and a receptacle 300 (FIG. 3), each having contacts or pins (not shown) for mating engagement. The contact configuration for each of the plug 210 and receptacle 300 correspond such that the receptacle 300 mates with the plug 210. The connector 205 shown in FIG. 2 is in a disconnected state. In certain embodiments, the receptacle 300 includes mating threads 215 for mating with corresponding threads (not shown) within a coupling ring 220 on the plug 210 when the plug 210 and receptacle 300 are in a connected state (not shown). In certain embodiments, the connector 205 includes a mounting flange 305 on the receptacle 300 for mounting to a surface of a wall, enclosure, or the like. In alternative embodiments, the connector 205 is an in-line connector, similar to an extension cord.

The connector system 200, including the connector 205 and Ethernet/power cable 100, can provide high-speed internet connection, up to 1 gigabit per second (gb/s), and is rated to 10,000 pounds per square inch (PSI). The connector system 200 provides 1000BaseT network performance and meet TIA/EIA-568-B.2. and IEEE 802.3-2005 standards Accordingly, the connector system 200 can provide both data and power communication in one assembly.

The shell size and number of contacts present within a connector can vary, as shown in the exemplary embodiments of FIGS. 3-7.

FIG. 3 is a front view of the receptacle 300 shown in FIG. 2. The receptacle 300 can be Series 5506 Flange Connector Receptacle commercially available from Cooper Interconnect, Gardena, Calif. The receptacle 300 includes a housing 310 which houses an insert 320 therein. The receptacle 300 includes a mounting flange 305 that extends orthogonally from the surface of the housing 310. The mounting flange 305 is used for mounting the receptacle 300 to a surface of a wall, enclosure, or the like. The receptacle 300 also includes a polarization key 325 that aids in aligning the contacts of the plug 210 with the receptacle 300 and preventing mismating of the connector 205.

The receptacle 300 can be configured in a variety of sizes and can include a varying amount of contacts for receiving power or data transmission. For example, the receptacle 300 can have a shell size 20, which indicates an insert 320 having a diameter of 0.979 inches. The insert 320 includes 21 contacts 330. Each of the contacts 330 has a diameter of about 1/16 inch. The contacts 330 include three power conductor pins, four network pair pins, and ten grounding pins. The contacts 330 are at least partially recessed below the surface of the insert 320 and configured so as to receive corresponding contacts (not shown) from the plug 210 when connected.

When connected to an Ethernet/power cable, the contacts 330 are coupled to one of a network pair 115 or a power conductor 110. The power conductors 110 are coupled to contacts 330 identified by 19, 20, and 21 in FIG. 3. The first network pair 115 is coupled to contacts 330 identified by 1 and 2 in FIG. 3, the second network pair 115 is coupled to contacts 330 identified by 4 and 5 in FIG. 3, the third network pair 115 is coupled to contacts 330 identified by 10 and 11 in FIG. 3, and the fourth network pair 115 is coupled to contacts 330 identified by 13 and 14 in FIG. 3. The contacts 330 identified by 3, 6, 7, 8, 9, 12, 15, 16, 17, and 18 in FIG. 3 are grounded. The grounding of contacts 330 identified by 3, 6, 7, 8, 9, 12, 15, 16, 17, and 18 effectively shields the network pairs 115 from each other, and further shields the network pairs 115 from the power conductors 110.

The distance between the network pairs 115 at contacts 330 identified by 4, 5 and 13, 14 (and correspondingly between network pairs 115 at contacts 330 identified by 1, 2 and 10, 11) is 0.219 inches. The distance between the contacts 330 identified by 4 and 5 (and correspondingly between each adjacent contact 330 on a single row) is 0.100 inches. The distances described between network pair contacts and adjacent contacts are merely exemplary, and can vary between connectors depending on the application. The minimum distance required between network pair contacts and adjacent contacts is a function of impedance. To achieve a 100 ohm requirement of a 1000BaseT Ethernet transmission, the nominal distance is calculated as a function of the dielectric constant of the material and separation distance given the impedance value.

FIG. 4 is a front view of a receptacle 400 according to an exemplary embodiment. A connector system can include the receptacle 400 and a corresponding plug (not shown). In this exemplary embodiment, the receptacle 400 includes power contacts 430 identified by 19, 20, and 21 that have a diameter of 3/32. The remaining contacts 430 (for network and grounding) are 1/16 of an inch.

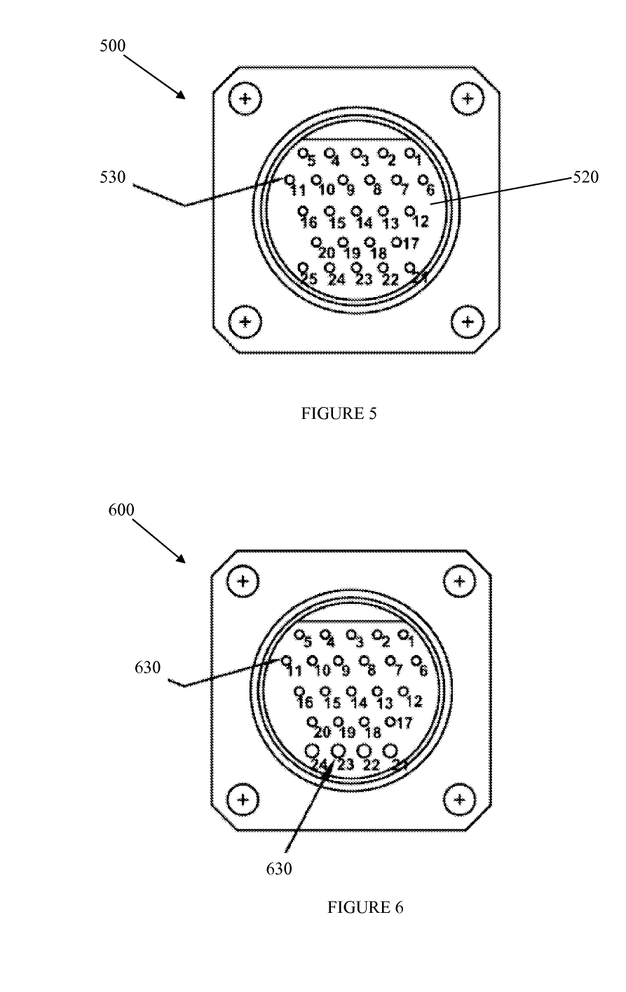

FIG. 5 is a front view of a receptacle 500 according to an exemplary embodiment. A connector system of the present invention can include the receptacle 500 and a corresponding plug (not shown). The receptacle 500 is similar to the receptacle 300, the difference being in the shell size and the number of contacts present. The receptacle 500 houses an insert 520 therein. The receptacle 500 has a shell size 24, which indicates the insert 520 having a diameter of 1.230 inches. The insert 520 includes 25 contacts 530. Each of the contacts 530 has a diameter of about 1/16 inch. The contacts 530 include five power conductor pins, four network pair pins, and twelve grounding pins.

When connected to an Ethernet/power cable, the contacts 530 are coupled to one of a network pair 115 or a power conductor 110. The power conductors 110 are coupled to the contacts 530 identified by 21, 22, 23, 24, and 25 in FIG. 5. The first network pair 115 is coupled to the contacts 530 identified by 1 and 2 in FIG. 5, the second network pair 115 is coupled to the contacts 530 identified by 4 and 5 in FIG. 5, the third network pair 115 is coupled to the contacts 530 identified by 12 and 13 in FIG. 5, and the fourth network pair 115 is coupled to the contacts 530 identified by 15 and 16 in FIG. 5. The contacts 530 identified by 3, 6, 7, 8, 9, 10, 11, 14, 17, 18, 19, and 20 in FIG. 5 are grounded. The grounding of the contacts 530 identified by 3, 6, 7, 8, 9, 10, 11, 14, 17, 18, 19, and 20 effectively shields the network pairs 115 from each other, and further shields the network pairs 115 from the power conductors 110.

The distance between the network pairs 115 at the contacts 530 identified by 4, 5 and 15, 16 (and correspondingly between the network pairs 115 at the contacts 530 identified by 1, 2 and 12, 13) is 0.254 inches. The distance between the contacts 530 identified by 4 and 5 (and correspondingly between each adjacent contact 530 on a single row) is 0.120 inches.

FIG. 6 is a front view of a receptacle 600 according to an exemplary embodiment. A connector system of the present invention can include the receptacle 600 and a corresponding plug (not shown). The receptacle 600 similar to the receptacle 500, the difference being in the number and diameter of power conductor pins present. The receptacle 600 has a shell size 24 and includes 24 contacts 630. The receptacle 600 includes four power conductor pins, four network pair pins, and twelve grounding pins. The power contacts 630 identified by 21, 22, 23, and 24 have a diameter of 3/32 of an inch. The remaining contacts 630 (for network and grounding) are 1/16 of an inch.

When connected to an Ethernet/power cable, the contacts 630 are coupled to one of a network pair 115 or a power conductor 110. The power conductors 110 are coupled to the contacts 630 identified by 21, 22, 23, and 24 in FIG. 6. The first network pair 115 is coupled to the contacts 630 identified by 1 and 2 in FIG. 6, the second network pair 115 is coupled to the contacts 630 identified by 4 and 5 in FIG. 6, the third network pair 115 is coupled to the contacts 630 identified by 12 and 13 in FIG. 6, and the fourth network pair 115 is coupled to the contacts 630 identified by 15 and 16 in FIG. 6. The contacts 630 identified by 3, 6, 7, 8, 9, 10, 11, 14, 17, 18, 19, and 20 in FIG. 6 are grounded.

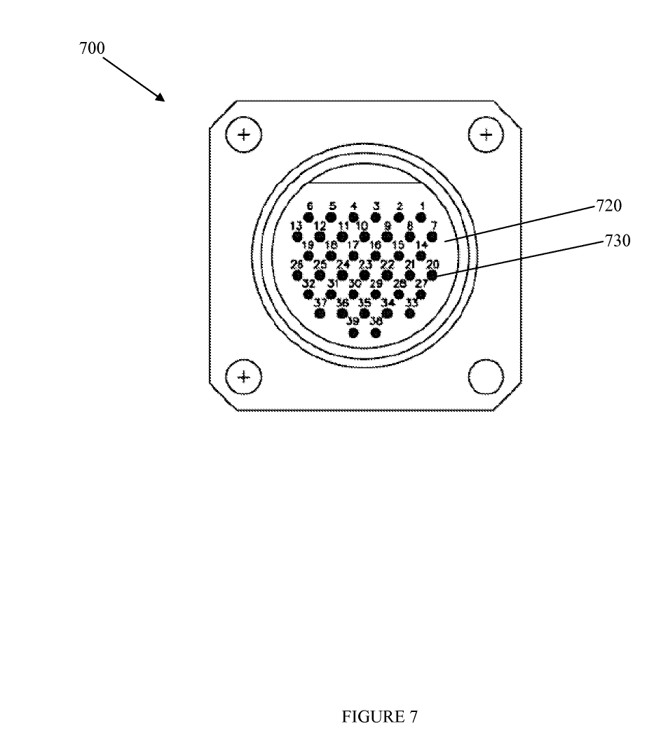

FIG. 7 is a front view of a receptacle 700 according to an exemplary embodiment. A connector system of the present invention can include the receptacle 700 and a corresponding plug (not shown). The receptacle 700 is similar to the receptacle 300, the difference being in the shell size and the number of contacts present. The receptacle 700 houses an insert 720 therein. The receptacle 700 has a shell size 32, which indicates the insert 720 having a diameter of 2 inches. The insert 720 includes 39 contacts 730. Each of the contacts 730 has a diameter of about 1/16 inch. The contacts 730 include fifteen power conductor pins, four network pair pins, and sixteen grounding pins.

When connected to an Ethernet/power cable, the contacts 730 are coupled to one of a network pair 115 or a power conductor 110. The power conductors 110 are coupled to the contacts 730 identified by 10, 23, 27, 28, 29, 30, 31, 32, 33, 34, 35, 36, 37, 38, and 39 in FIG. 7. The first network pair 115 is coupled to the contacts 730 identified by 1 and 2 in FIG. 7, the second network pair 115 is coupled to the contacts 730 identified by 5 and 6 in FIG. 7, the third network pair 115 is coupled to the contacts 730 identified by 14 and 15 in FIG. 7, and the fourth network pair 115 is coupled to the contacts 730 identified by 18 and 19 in FIG. 7. The contacts 730 identified by 3, 4, 7, 8, 9, 11, 12, 13, 16, 17, 20, 21, 22, 24, 25, and 26 in FIG. 7 are grounded. The grounding of the contacts 730 identified by 3, 4, 7, 8, 9, 11, 12, 13, 16, 17, 20, 21, 22, 24, 25, and 26 effectively shields the network pairs 115 from each other, and further shields the network pairs 115 from the power conductors 110.

Generally, the connector systems of the present invention include an Ethernet/power cable coupled to a connector. The cable is coupled to the connector such that the network pairs are shielded from each other using grounding pins, and the network pairs are shielded from the power conductors using grounding pins.

The connectors of the present invention can match impedance with the Ethernet/power cable. Impedance matching can be achieved by (i) the use of a dielectric in connector construction, and (ii) proper shielding between the power conductors and the network pairs. Impedance matching results in an increase in the probability that a network signal passes through undamaged and without errors. Impedance matching also results in less likelihood of signal loss. Shielding between power and network contacts is influenced by the ratio of the size/diameter of the contacts to the spacing between the contacts. The connector systems of the present invention are configured to optimally shield the power conductors from the network wires.

To facilitate a better understanding of the present invention, the following example of certain aspects of some embodiments are given. In no way should the following example be read to limit, or define, the scope of the invention.

### EXAMPLE

Three double-ended underwater Ethernet/power cable plug assemblies (5999-1049-Exxx commercially available from Cooper Interconnect) were manufactured; one cable plug assembly had a length of about 2 meters, a second cable plug assembly had a length of about 25 meters, and a third cable plug assembly had a length of about 50 meters. Two panel mount receptacles with Ethernet/power cables (5506-2021-Exxx commercially available from Cooper Interconnect) were manufactured to mate to each side of the double-ended plug assembly. Prior to any hydrostatic pressure testing, the entire assembly (plug cable and receptacle) was mated and electrically tested for insulation resistance, continuity, as well as 1000BaseT (1 gb/s) performance with a Fluke Networks© DTX-1800 analyzer.

For hydrostatic pressure testing, a 10,000 PSI rated hydrostatic pressure chamber was used to test the units. The two panel mount receptacles with Ethernet/power cables were bolted to a fixture and then secured on top of the pressure chamber. The individual leads from the receptacles were then connected to the appropriate electrical tester. The three power leads were connected to a Megaohm meter, or “megger”, and the network pairs were connected to the Fluke Networks© DTX-1800 analyzer. Thereafter, the double-ended plug was tightly installed for each of the receptacles on the fixture and lowered into the test chamber filled with water. The top of the chamber was tightly secured and the pressure gauge zeroed. A continuity test was performed from one receptacle end through the cable plug assembly to the other receptacle to insure the electrical integrity of the assembly before raising the pressure.

An initial reading was taken at zero pressure. A megger test potential of 500 volts of direct current (VDC) on the power conductors was kept while checking for the 1000BaseT performance of the cable. The hydrostatic pressure was then raised at the rate between 125 and 500 PSI per minute. At every 500 PSI, each cable plug assembly was tested for 1000/100/10BaseT pass or fail with the Fluke Networks© DTX-1800 analyzer while continuing to apply 500 VDC potential on the power conductors. Once the hydrostatic pressure reached 5000 PSI, each cable plug assembly was kept at that pressure for 15 minutes and then a reading was taken. Results from the test are shown in Table 1 below.

TABLE 1
Results from hydrostatic pressure testing of Ethernet/power
cable plug assemblies.

| Hydrostatic | | | |
|---|---|---|---|
| Pressure (PSI) | 10BaseT | 100BaseT | 1000BaseT |
| Initial - 0 | PASS | PASS | PASS |
| 1000 | PASS | PASS | PASS |
| 2000 | PASS | PASS | PASS |
| 3000 | PASS | PASS | PASS |
| 4000 | PASS | PASS | PASS |
| 5000 | PASS | PASS | PASS |

As evident from Table 1 above, the test assemblies retained their 1000BaseT performance at 500 PSI hydrostatic pressure. In addition, the potential applied to the power conductors did not affect performance of the assemblies.

Therefore, the present invention is well adapted to attain the ends and advantages mentioned as well as those that are inherent therein. The particular embodiments disclosed above are illustrative only, as the present invention may be modified and practiced in different but equivalent manners apparent to those having ordinary skill in the art having the benefit of the teachings herein. Having described some exemplary embodiments of the present invention, it is believed that the use of alternate connector configurations is within the purview of those having ordinary skill in the art. Additionally, while the present application generally illustrates cylindrical connectors, it is understood that a number of other non-circular configurations may be used. Also, while contacts having a diameter of 1/16 or 3/32 of an inch have been discussed, a person having ordinary skill in the art will recognize that the sizes of the contacts can vary from connector to connector and within a connector itself. One having ordinary skill in the art will also recognize that any number of contacts may be utilized in the connector systems of the present invention as long as the network pairs are effectively shielded from each other and from the power contacts. It is therefore evident that the particular illustrative embodiments disclosed above may be altered or modified and all such variations are considered within the scope and spirit of the present invention.

What is claimed is:

1. A plug assembly comprising:
a cable having at least one power conductor and at least one data communication wire; and
a plug configured to couple to the cable, the plug comprising:
a housing;
an insert assembly disposed in the housing;
a plurality of pins protruding from the insert assembly, wherein a first number of the pins are coupled to the at least one power conductor and a second number of the pins are coupled to the at least data communication wire, and wherein the at least one data communication wire is shielded from the at least one power conductor.

2. The plug assembly of claim 1, wherein the plurality of pins comprises grounding pins, and wherein the grounding pins are positioned between the at least one data communication wire and the at least one power conductor.

3. The plug assembly of claim 1, the cable having an even number of data communication wires, wherein two data communication wires form a network pair, and wherein the network pairs are shielded from one another.

4. The plug assembly of claim 3, wherein the plurality of pins comprises grounding pins, and wherein the grounding pins are positioned between network pairs.

5. The plug assembly of claim 1, wherein the first number of the pins have a diameter different from the second number of the pins.

6. A receptacle assembly comprising:
a cable having at least one power conductor and at least one data communication wire; and
a receptacle configured to couple to the cable, the receptacle comprising:
a housing;
an insert assembly disposed in the housing;
a plurality of pins at least partially recessed within the insert assembly, wherein a first number of the pins are coupled to the at least one power conductor and a second number of the pins are coupled to the at least data communication wire, and wherein the at least one data communication wire is shielded from the at least one power conductor.

7. The receptacle assembly of claim 6, wherein the plurality of pins comprises grounding pins, and wherein the grounding pins are positioned between the at least one data communication wire and the at least one power conductor.

8. The receptacle assembly of claim 6, the cable having an even number of data communication wires, wherein two data communication wires form a network pair, and wherein the network pairs are shielded from one another.

9. The receptacle assembly of claim 8, wherein the plurality of pins comprises grounding pins, and wherein the grounding pins are positioned between network pairs.

10. The plug assembly of claim 6, wherein the first number of the pins have a diameter different from the second number of the pins.

11. A connector system comprising:
a first cable having at least one first power conductor and at least one first data transmission wire;
a receptacle configured to couple to the first cable, the receptacle comprising:
a first insert assembly;
a first plurality of pins at least partially recessed within the first insert assembly, wherein a first portion of the first plurality of pins are coupled to the at least one first power conductor and a second portion of the first plurality of pins are coupled to the at least one first data transmission wire;
a second cable having at least one second power conductor and at least one second data transmission wire; and
a plug configured to couple to the second cable, the plug comprising:
a second insert assembly;
a second plurality of pins protruding from the second insert assembly, wherein a first portion of the second plurality of pins are coupled to the at least one second power conductor and a second portion of the second plurality of pins are coupled to the at least one second data transmission wire,
wherein the number of second plurality of pins corresponds to the number of first plurality of pins and contact each other when the plug and receptacle are mated together.

12. The connector system of claim 11, wherein the receptacle further comprises a first housing, and wherein the first insert assembly is disposed in the first housing.

13. The connector system of claim 11, wherein the plug further comprises a second housing, and wherein the second insert assembly is disposed in the second housing.

14. The connector system of claim 11, wherein the at least one first data transmission wire is shielded from at least one first power conductor.

15. The connector system of claim 14, wherein the first plurality of pins comprises first grounding pins, and wherein the first grounding pins are positioned between the at least one first data transmission wire and the at least one first power conductor.

16. The connector system of claim 11, the first cable having an even number of first data transmission wires, wherein two first data transmission wires form a first network pair, and wherein the first network pairs are shielded from one another.

17. The connector system of claim 16, wherein the first plurality of pins comprises first grounding pins, and wherein the first grounding pins are positioned between the first network pairs.

18. The connector system of claim 11, wherein the at least one second data transmission wire is shielded from at least one second power conductor.

19. The connector system of claim 18, wherein the second plurality of pins comprises second grounding pins, and wherein the second grounding pins are positioned between the at least one second data transmission wire and the at least one second power conductor.

20. The connector system of claim 11, the second cable having an even number of second data transmission wires, wherein two second data transmission wires form a second network pair, and wherein the second network pairs are shielded from one another.

21. The connector system of claim 20, wherein the second plurality of pins comprises second grounding pins, and wherein the second grounding pins are positioned between the second network pairs.
